(19) United States
(12) Patent Application Publication
(10) Pub. No.: US 2026/0246012 A1
(43) Pub. Date: Aug. 20, 2026

(54) BATTERY PACK FRAME

(71) Applicant: SK ON CO., LTD., Seoul (KR)

(72) Inventors: Jung Kwan LEE, Daejeon (KR); Seung Il KWAK, Daejeon (KR); Dae Won KWON, Daejeon (KR); Ji Woong KIM, Daejeon (KR)

(21) Appl. No.: 19/435,776

(22) Filed: Dec. 30, 2025

(30) Foreign Application Priority Data
Feb. 14, 2025 (KR) 10-2025-0019381

(51) Int. Cl. H01M 10/6554; H01M 10/613; H01M 10/625; H01M 10/656; H01M 50/242; H01M 50/249; B60L 50/64

(52) U.S. Cl. CPC H01M 10/6554; H01M 10/613; H01M 10/625; H01M 10/656; H01M 50/242; H01M 50/249; B60L 50/64; H01M 2220/20

(57) ABSTRACT

A battery pack frame is disclosed. According to an embodiment of the present disclosure, the battery pack frame may include: a bottom frame including a loading plate defining an upper surface and an additional plate defining a lower surface; and side frames having a shape extending upward from at least a portion of a perimeter of the loading plate, wherein the additional plate may include: a cooling plate having a cooling passage formed therein; and a shock-absorbing plate including a shock-absorbing middle layer positioned beneath the cooling plate and an outer layer positioned beneath the shock-absorbing middle layer, wherein the shock-absorbing plate may include a plurality of shock-absorbing ribs sequentially arranged between the shock-absorbing middle layer and the outer layer.

### CROSS-REFERENCE TO RELATED APPLICATION

This patent application claims the priority and benefits of Korean patent application No. 10-2025-0019381, filed on February 14, 2025, the disclosure of which is incorporated herein by reference in its entirety.

### BACKGROUND OF THE INVENTION

### 1. Field of the Invention

The present disclosure relates to a battery pack frame.

### 2. Description of the Related Art

Secondary batteries used in an electric vehicle or the like may be loaded into a battery pack frame. The battery pack frame may cool the secondary batteries and protect them from an external impact. In this regard, a battery pack frame capable of effectively protecting the secondary batteries from an external impact is required.

### SUMMARY OF THE INVENTION

According to an aspect of the present disclosure, there is provided a battery pack frame that facilitates maintenance or replacement.

According to another aspect of the present disclosure, there is provided a battery pack frame that includes a shock-absorbing plate configured to protect a cooling plate from an external impact.

A battery pack frame according to the present disclosure may include: a bottom frame including a loading plate defining an upper surface and an additional plate defining a lower surface; and side frames having a shape extending upward from at least a portion of a perimeter of the loading plate, wherein the additional plate may include: a cooling plate having a cooling passage formed therein; and a shock-absorbing plate including a shock-absorbing middle layer positioned beneath the cooling plate and an outer layer positioned beneath the shock-absorbing middle layer, and the shock-absorbing plate may include a plurality of shock-absorbing ribs sequentially arranged between the shock-absorbing middle layer and the outer layer.

At least two adjacent shock-absorbing ribs among the plurality of shock-absorbing ribs may overlap each other in a vertical direction.

Each of the plurality of shock-absorbing ribs may be inclined with respect to the outer layer and the shock-absorbing middle layer.

The shock-absorbing plate may include a shock-absorbing space formed between the outer layer and the shock-absorbing middle layer.

The shock-absorbing plate may include a shock-absorbing body disposed in the shock-absorbing space and formed of an elastic material.

The plurality of shock-absorbing ribs may include a plurality of first arc ribs and a plurality of second arc ribs alternately arranged in one direction, and a shape of the first arc rib may be vertically symmetrical with a shape of the second arc rib.

Each of the first arc ribs and the second arc ribs may include: a main arc coupled to at least one of the outer layer and the shock-absorbing middle layer; and a sub-arc coupled to the main arc.

The main arc of the first arc rib may be connected to the outer layer and may be concave toward the outer layer and convex toward the shock-absorbing middle layer, and the main arc of the second arc rib may be connected to the shock-absorbing middle layer and may be concave toward the shock-absorbing middle layer and convex toward the outer layer.

The sub-arc of the first arc rib may be convex toward the outer layer, and the sub-arc of the second arc rib may be convex toward the shock-absorbing middle layer.

The shock-absorbing plate may be detachably coupled to the cooling plate through a coupling part.

The additional plate may be disposed between the cooling plate and the shock-absorbing plate and may include an insulation plate formed of an insulating material.

The cooling plate may include: an inner layer defining an upper surface of the cooling plate; a cooling middle layer positioned beneath the inner layer and coupled to the shock-absorbing middle layer; the cooling passage, which is a space formed between the inner layer and the cooling middle layer; and a cooling wall positioned between the inner layer and the cooling middle layer and defining the cooling passage.

The inner layer may be integrally formed with the loading plate.

The cooling middle layer may be integrally formed with the shock-absorbing middle layer.

The additional plate further may include an insulation plate disposed between the cooling plate and the shock-absorbing plate and having an insulation space formed therein.

The insulation plate may include: an insulating top layer integrally formed with the cooling middle layer; an insulating bottom layer integrally formed with the shock-absorbing middle layer; and an insulating wall extending downward from the insulating top layer to the insulating bottom layer.

The insulation space may be formed between the insulating top layer and the insulating bottom layer and may be defined by the insulating wall.

The plurality of shock-absorbing ribs each may be an S-rib formed in an “S” shape and having one end coupled to the outer layer and the other end coupled to the shock-absorbing middle layer.

The additional plate may include: a plurality of cooling plates, each arranged in one direction as the cooling plate; and a plurality of shock-absorbing plates, each arranged in the one direction as the shock-absorbing plate.

The cooling plate has a shape extending in a longitudinal direction, and the additional plate may include a plurality of shock-absorbing plates, each arranged sequentially in the longitudinal direction as the shock-absorbing plate.

A battery pack frame according to the present disclosure may include: a bottom frame including a loading plate defining an upper surface and an additional plate defining a lower surface; and side frames having a shape extending upward from at least a portion of a perimeter of the loading plate, wherein the additional plate may include: a cooling plate having a cooling passage formed therein; and a shock-absorbing plate including a shock-absorbing middle layer positioned beneath the cooling plate and an outer layer positioned beneath the shock-absorbing middle layer, and the shock-absorbing plate may include a plurality of shock-absorbing ribs sequentially arranged between the shock-absorbing middle layer and the outer layer.

According to an embodiment of the present disclosure, maintenance or replacement of the battery pack frame may be facilitated.

According to an embodiment of the present disclosure, the battery pack frame may include the shock-absorbing plate configured to protect the cooling plate from an external impact.

The battery pack frame of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are a perspective view and a plan view illustrating a battery pack frame according to an embodiment of the present disclosure;

FIG. 3 is an exploded perspective view of an additional plate according to an embodiment;

FIG. 4 is a cross-sectional view of the additional plate;

FIG. 5 is a cross-sectional view of the additional plate, illustrating a state in which a shock-absorbing plate and a cooling plate are coupled to each other by a coupling part;

FIG. 6 is an exploded perspective view illustrating a lower portion of the battery pack frame, specifically showing the shock-absorbing plate coupled to an insulation plate;

FIG. 7 is a cross-sectional view of a bottom frame according to an embodiment of the present disclosure, with a portion thereof enlarged;

FIG. 8 is a cross-sectional view of a shock-absorbing plate including arc ribs;

FIG. 9 is a cross-sectional view of a shock-absorbing plate including S-ribs;

FIG. 10 is a cross-sectional view of an additional plate having an insulation space formed in the insulation plate; and

FIG. 11 is a cross-sectional view of an additional plate including a shock-absorbing body.

### DETAILED DESCRIPTION OF THE INVENTION

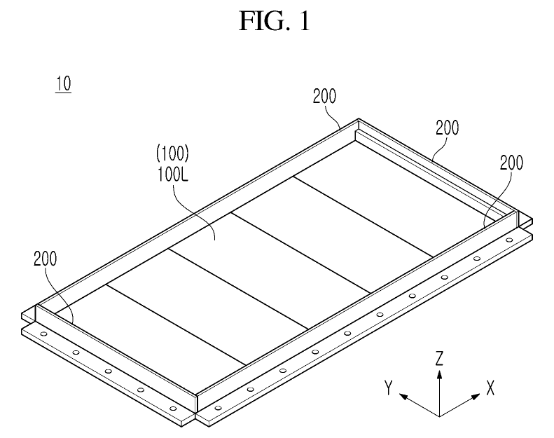

Hereinafter, the present disclosure will be described in detail with reference to FIGS. 1 to 11. However, these are merely illustrative, and the present disclosure is not limited to the specific embodiments described as examples.

An XYZ coordinate system may be used in this specification. The XYZ coordinate system may be a Cartesian coordinate system.

For example, the Z-axis may be parallel to the vertical direction. For instance, a positive Z-axis direction may represent the upward direction, and a negative Z-axis direction may represent the downward direction.

For example, the X-axis may be parallel to the front-rear direction. For instance, a positive X-axis direction may represent the forward direction, and a negative X-axis direction may represent the rearward direction.

For example, the Y-axis may be parallel to the left-right direction. For instance, a positive Y-axis direction may represent the leftward direction, and a negative Y-axis direction may represent the rightward direction.

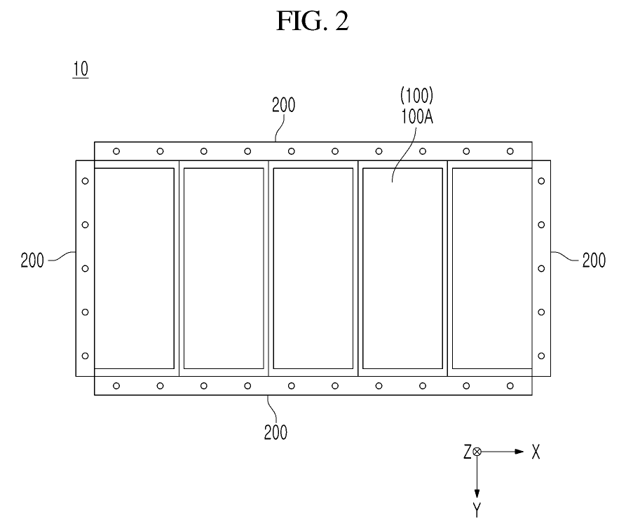

FIGS. 1 and 2 are a perspective view and a plan view illustrating a battery pack frame according to an embodiment of the present disclosure.

Referring to FIGS. 1 and 2, a battery pack frame 10 may include a bottom frame 100. The bottom frame 100 may define a bottom of the battery pack frame 10.

For example, the bottom frame 100 may have a plate shape. For example, the bottom frame 100 may have an upper surface that faces or is directed upward. For example, the bottom frame 100 may have a lower surface that faces or is directed downward.

The bottom frame 100 may have sides or edges. For example, the bottom frame 100 may have two sides extending in a longitudinal direction of the bottom frame 100. The longitudinal direction of the bottom frame 100 may correspond to, for example, the front-rear direction.

For example, the bottom frame 100 may have two sides extending in a widthwise direction of the bottom frame 100. The widthwise direction of the bottom frame 100 may correspond to, for example, the left-right direction.

The battery pack frame 10 may include side frames 200. The side frames 200 may be connected or coupled to the bottom frame 100. For example, the side frames 200 may be connected or coupled to respective sides of the bottom frame 100 extending in the widthwise direction.

For example, the side frame 200 may have a shape extending upward from a perimeter of the bottom frame 100. For example, the side frame 200 and the bottom frame 100 may define a space that is open upward.

The bottom frame 100 may include a plurality of layers. For example, the bottom frame 100 may include a loading plate 100L. The loading plate 100L may define an upper surface of the bottom frame 100. For example, an upper surface of the loading plate 100L may serve as the upper surface of the bottom frame 100.

The battery pack frame 10 may load at least one of a battery module and a battery cell. The battery module may include a plurality of battery cells.

For example, the battery module or battery cell may be positioned on the loading plate 100L. For example, the loading plate 100L may be in contact with the battery module or the battery cell.

The battery pack frame 10 may include an additional plate 100A. For example, the additional plate 100A may be coupled to the loading plate 100L. For example, the additional plate 100A may be disposed to face a lower surface of the loading plate 100L.

For example, the additional plate 100A may define a lower surface of the bottom frame 100. For example, a lower surface of the additional plate 100A may serve as the lower surface of the bottom frame 100.

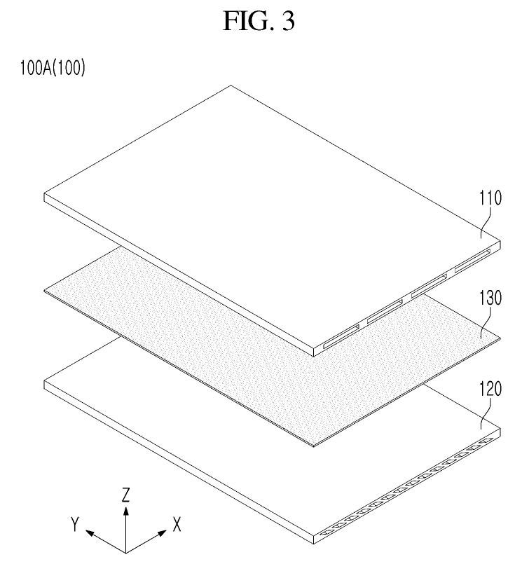

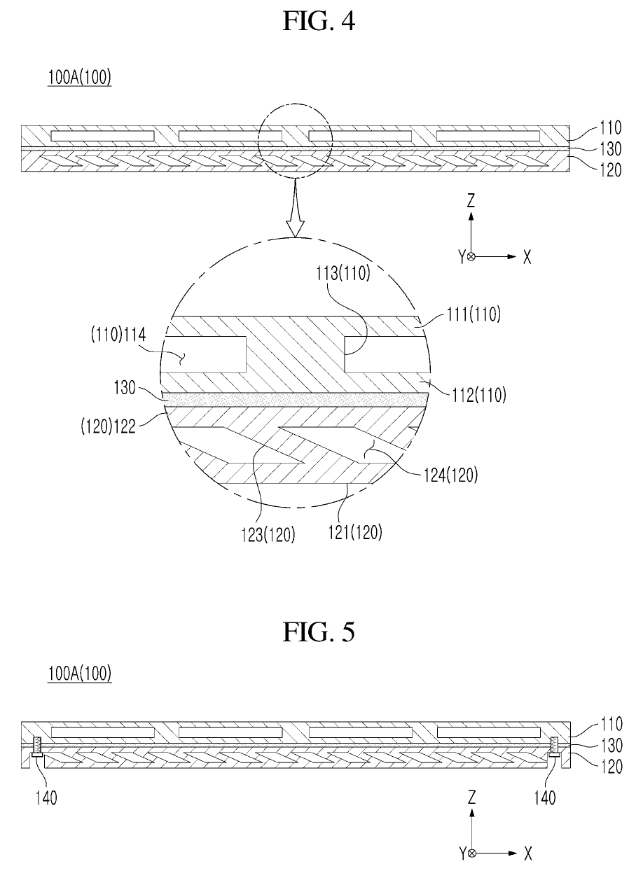

FIG. 3 is an exploded perspective view of the additional plate according to an embodiment. FIG. 4 is a cross-sectional view of the additional plate. Referring to FIGS. 3 and 4, the additional plate 100A may include a cooling plate 110.

The cooling plate 110 may include a plurality of layers. For example, the cooling plate 110 may include an inner layer 111 and a cooling middle layer 112.

The cooling plate 110 may define an upper surface of the additional plate 100A. For example, an upper surface of the inner layer 111 may serve as the upper surface of the additional plate 100A.

The cooling plate 110 may be in contact with or coupled to the loading plate 100L (see FIG. 1). For example, the inner layer 111 may be in contact with or coupled to the loading plate 100L (see FIG. 1).

The cooling plate 110 may include the cooling middle layer 112. The cooling middle layer 112 may be positioned beneath the inner layer 111. For example, the cooling middle layer 112 and the inner layer 111 may be spaced apart from each other.

The cooling plate 110 may include a cooling passage 114. For example, the cooling passage 114 may be defined as a gap between the cooling middle layer 112 and the inner layer 111.

The cooling middle layer 112 and the inner layer 111 may be connected to each other. For example, the cooling plate 110 may include a cooling wall 113 configured to connect the cooling middle layer 112 and the inner layer 111.

The cooling wall 113 may extend downward from the inner layer 111 to the cooling middle layer 112. The cooling wall 113 may partition a gap formed between the cooling middle layer 112 and the inner layer 111.

The cooling passage 114 may be a hollow portion formed in the cooling plate 110. For example, the cooling passage 114 may be a passage defined by the inner layer 111, the cooling middle layer 112, and the cooling wall 113.

In other words, the cooling passage 114 may be defined by the inner layer 111, the cooling middle layer 112, and the cooling wall 113. For example, the cooling passage 114 may extend from one end to the other end.

For example, one end and the other end of cooling passage 114 may be open. For example, coolant may be introduced into one end of cooling passage 114. The coolant may flow in the cooling passage 114. The coolant may be discharged to the outside from the other end of cooling passage 114.

Heat may be generated from a battery loaded on the battery pack frame 10 (see FIG. 1). At least a portion of the heat generated from the battery (not shown) may be transferred to the loading plate 100L (see FIG. 1).

At least a portion of the heat transferred to the loading plate 100L (see FIG. 1) may be further transferred to the cooling plate 110. At least a portion of the heat transferred to the cooling plate 110 may be transferred to the coolant.

The cooling plate 110 may be integrally formed with the loading plate 100L (see FIG. 1). For example, the inner layer 111 may be integrally formed with the loading plate 100L (see FIG. 1). In this case, at least a portion of the heat transferred to the loading plate 100L (see FIG. 1) may be transferred to the coolant.

The temperature of the coolant introduced into the cooling passage 114 may be lower than the temperature of the cooling plate 110. Accordingly, an increase in the temperature of the battery (not shown) accommodated in the battery pack frame 10 (see FIG. 1) may be effectively suppressed.

The battery pack frame 10 (see FIG. 1) may be installed in a vehicle. For example, the battery pack frame 10 (see FIG. 1) may define a lower portion of the vehicle. For example, the cooling plate 110 may need to be protected from an external impact and the like.

The additional plate 100A may include a shock-absorbing plate 120. The shock-absorbing plate 120 may be positioned beneath the cooling plate 110. For example, the shock-absorbing plate 120 may be coupled or connected to the cooling plate 110 via an insulation plate 130.

The additional plate 100A may include the insulation plate 130. The insulation plate 130 may be disposed between the cooling plate 110 and the shock-absorbing plate 120. The insulation plate 130 may be formed of a material including an insulating material.

The shock-absorbing plate 120 may include a plurality of layers. For example, the shock-absorbing plate 120 may include an outer layer 121 and a shock-absorbing middle layer 122.

The outer layer 121 may define a lower surface of the shock-absorbing plate 120. The shock-absorbing middle layer 122 may define an upper surface of the shock-absorbing plate 120. The shock-absorbing middle layer 122 may be disposed above the outer layer 121 with a spacing therebetween.

The shock-absorbing plate 120 may include a plurality of shock-absorbing ribs 123. The shock-absorbing ribs 123 may extend upward from the outer layer 121 to the shock-absorbing middle layer 122.

The shock-absorbing ribs 123 may be inclined with respect to the outer layer 121 and the shock-absorbing middle layer 122. For example, at least two adjacent shock-absorbing ribs 123 among the plurality of shock-absorbing ribs 123 may overlap in the vertical direction.

If an external impact is applied to the outer layer 121 from below the outer layer 121, at least a portion of the external impact applied to the outer layer 121 may be delivered to the shock-absorbing ribs 123.

For example, if an external force is applied to the shock-absorbing ribs 123, a shape of the shock-absorbing ribs 123 may be deformed. In another example, if an external force is applied to the shock-absorbing ribs 123, the shock-absorbing ribs 123 may be fractured.

Accordingly, at least a portion of the external impact applied to the shock-absorbing plate 120 may be absorbed by the shock-absorbing plate 120, and the cooling plate 110 may be effectively protected from the external impact.

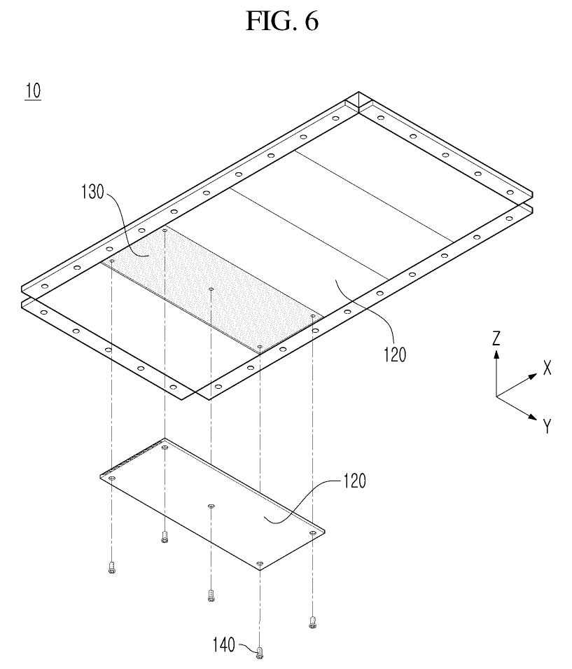

FIG. 5 is a cross-sectional view of the additional plate, illustrating a state in which the shock-absorbing plate and the cooling plate are coupled to each other by a coupling part. FIG. 6 is an exploded perspective view illustrating a lower portion of the battery pack frame, specifically showing the shock-absorbing plate coupled to the insulation plate.

Referring to FIGS. 5 and 6, the additional plate 100A may include a coupling part 140. For example, the coupling part 140 may couple the shock-absorbing plate 120 and the cooling plate 110. For example, the coupling part 140 may couple the insulation plate 130 to the shock-absorbing plate 120 and the cooling plate 110.

The coupling part 140 may include, for example, a screw. For example, the coupling part 140 may sequentially penetrate the shock-absorbing plate 120 and the insulation plate 130, and may be inserted into the cooling plate 110 so as to be coupled thereto.

The coupling between the coupling part 140 and the cooling plate 110 may be released. If an impact is applied to the shock-absorbing plate 120, the shock-absorbing plate 120 may be damaged, while the cooling plate 110 may function normally. In this case, the shock-absorbing plate 120 may need to be replaced.

If the shock-absorbing plate 120 needs to be replaced, the coupling between the coupling part 140 and the cooling plate 110 may be released, and the damaged shock-absorbing plate 120 may be discarded. A new shock-absorbing plate 120 may be coupled to the cooling plate 110 and the insulation plate 130 through the coupling part 140.

Referring to FIGS. 1 to 6, a region of the bottom frame 100 may be partitioned. For example, the battery pack frame 10 may include a plurality of bottom frames 100.

The plurality of bottom frames 100 may be sequentially arranged in one direction. For example, the plurality of bottom frames 100 may be sequentially arranged in a longitudinal direction of the battery pack frame 10. The longitudinal direction of the battery pack frame 10 may be, for example, parallel to the X-axis.

If an external impact is applied to the battery pack frame 10 from below the battery pack frame 10, some of the plurality of bottom frames 100 may be damaged, while others may be preserved. In this case, only the damaged ones among the plurality of bottom frames 100 may be replaced.

If an external impact is applied to the battery pack frame 10 from below the battery pack frame 10, the shock-absorbing plate 120 may absorb at least a portion of the external impact. In this case, the shock-absorbing plate 120 may be damaged.

For example, the shock-absorbing plate 120 may be damaged, while the cooling plate 110 may be preserved. For example, only the damaged ones among the plurality of shock-absorbing plates 120 may be replaced.

In another example, the loading plate 100L may be integrally formed, and a plurality of additional plates 100A may be sequentially arranged beneath the loading plate 100L.

In another example, the cooling plate 110 may be integrally formed, and a plurality of shock-absorbing plates 120 may be sequentially arranged beneath the cooling plate 110.

By sequentially arranging the plurality of shock-absorbing plates 120, maintenance or replacement of the additional plate 100A may be facilitated.

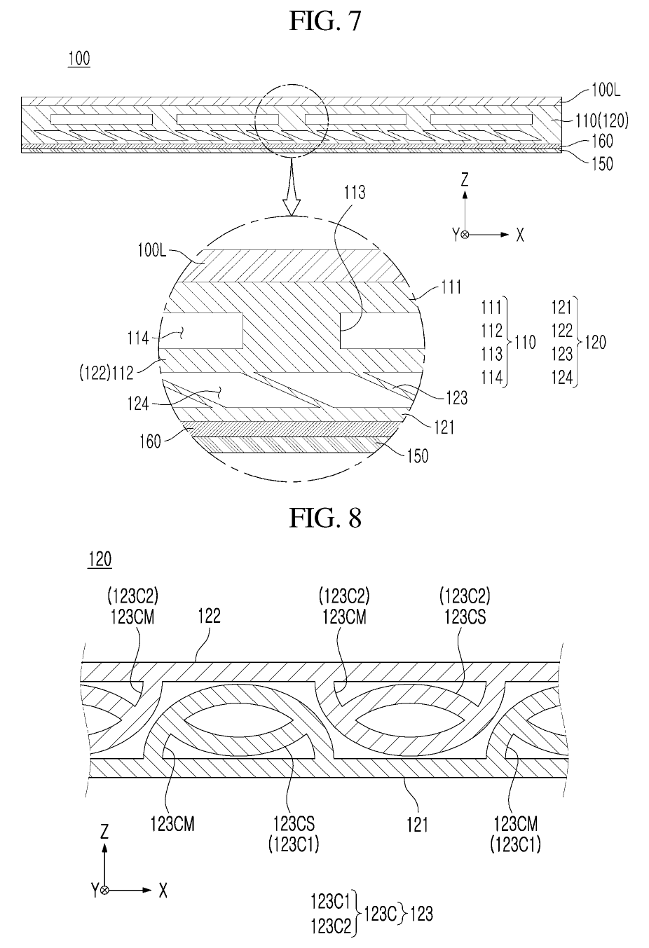

FIG. 7 is a cross-sectional view of the bottom frame according to an embodiment of the present disclosure, with a portion thereof enlarged.

Referring to FIGS. 1, 2 and 7, the cooling plate 110 may be positioned beneath the loading plate 100L. For example, the inner layer 111 may be in contact with the lower surface of the loading plate 100L.

In another example, the cooling plate 110 may be integrally formed with the loading plate 100L. For example, the inner layer 111 may be integrally formed with the loading plate 100L.

The shock-absorbing plate 120 may be positioned beneath the cooling plate 110. For example, the shock-absorbing middle layer 122 may be in contact with a lower surface of the cooling middle layer 112.

In another example, the shock-absorbing plate 120 may be integrally formed with the cooling plate 110. For example, the shock-absorbing middle layer 122 may be integrally formed with the cooling middle layer 112. In this case, the shock-absorbing middle layer 122 or the cooling middle layer 112 may be referred to as a “middle layer.”

The inner layer 111 may have a thickness greater than or equal to that of the middle layers 112 and 122. By ensuring that the inner layer 111 has a thickness greater than or equal to a certain level, the cooling plate 110 may stably support the loading plate 100L. For example, when the inner layer 111 has a thickness secured to a certain level or greater, the cooling plate 110 may stably support a secondary battery (not shown).

The middle layers 112 and 122 may have a thickness greater than or equal to that of the outer layer 121. When the middle layers 112 and 122 have a thickness secured to a certain level or greater, a shape of the cooling passage 114 may be stably maintained.

The outer layer 121 may have a thickness greater than or equal to that of the shock-absorbing rib 123. Accordingly, at least a portion of the impact applied to the outer layer 121 may be delivered to the shock-absorbing ribs 123, causing deformation in the shock-absorbing ribs 123, so that the external impact can be effectively absorbed by the shock-absorbing plate 120.

The bottom frame 100 may include a lower cover 150. The lower cover 150 may define the lower surface of the bottom frame 100. The lower cover 150 may primarily protect the cooling plate 110 from an external impact applied to the bottom frame 100 from below the bottom frame 100.

The bottom frame 100 may include an elastic board 160. The elastic board 160 may be disposed between the lower cover 150 and the shock-absorbing plate 120. For example, the elastic board 160 may be positioned on the lower cover 150 and beneath the outer layer 121.

For example, the elastic board 160 may be formed of a material including an elastic material. For example, the elastic board 160 may absorb at least a portion of the impact applied to the elastic board 160.

For example, the elastic board 160 may be formed of a material including an insulating material. For example, the elastic board 160 may inhibit transfer of heat of the cooling plate 110 to and from an exterior of the battery pack frame 10.

FIG. 8 is a cross-sectional view of a shock-absorbing plate including arc ribs.

Referring to FIG. 8, the shock-absorbing plate 120 may include arc ribs 123C. The shock-absorbing ribs 123 may include or refer to the arc ribs 123C.

A plurality of arc ribs 123C may be provided. For example, the shock-absorbing plate 120 may include a plurality of arc ribs 123C. The plurality of arc ribs 123C may be classified into a plurality of types.

For example, a first arc rib 123C1 and a second arc rib 123C2 may be different types of arc ribs 123C. For example, the arc rib 123C may include or refer to at least one of the first arc rib 123C1 and the second arc rib 123C2.

The arc rib 123C may include a main arc 123CM and a sub-arc 123CS. The main arc 123CM may be connected or coupled to at least one of the outer layer 121 and the shock-absorbing middle layer 122.

For example, the main arc 123CM of the first arc rib 123C1 may be concave toward the outer layer 121 and convex toward the shock-absorbing middle layer 122.

For example, the main arc 123CM of the second arc rib 123C2 may be convex toward the outer layer 121 and concave toward the shock-absorbing middle layer 122.

For example, the main arc 123CM of the first arc rib 123C1 may be connected or coupled to the outer layer 121. For example, the first arc rib 123C1 and the second arc rib 123C2 may extend from the outer layer 121 or the shock-absorbing middle layer 122.

The sub-arc 123CS may be coupled to the main arc 123CM. For example, the sub-arc 123CS may extend from the main arc 123CM. For example, a space may be formed between the sub-arc 123CS and the main arc 123CM.

For example, the sub-arc 123CS of the first arc rib 123C1 may be convex toward the outer layer 121. For example, the sub-arc 123CS of the second arc rib 123C2 may be convex toward the shock-absorbing middle layer 122.

A plurality of first arc ribs 123C1 and a plurality of second arc ribs 123C2 may be sequentially arranged. For example, the plurality of first arc ribs 123C1 and the plurality of second arc ribs 123C2 may be alternately arranged.

Among the plurality of first arc ribs 123C1 and the plurality of second arc ribs 123C2, one adjacent first arc rib 123C1 and one adjacent second arc rib 123C2 may overlap in the vertical direction.

For example, among the plurality of first arc ribs 123C1 and the plurality of second arc ribs 123C2, the main arc 123CM of one adjacent first arc rib 123C1 and the main arc 123CM of one adjacent second arc rib 123C2 may at least partially overlap in the vertical direction.

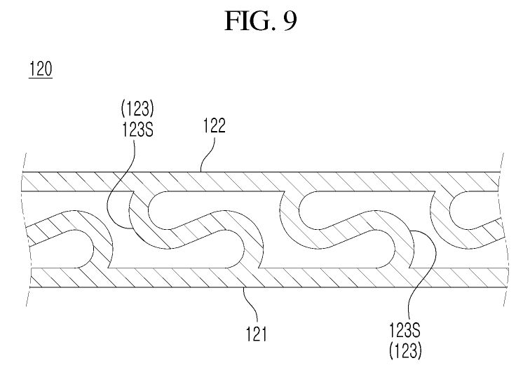

FIG. 9 is a cross-sectional view of a shock-absorbing plate including S-ribs.

Referring to FIG. 9, the shock-absorbing plate 120 may include S-ribs 123S. The shock-absorbing ribs 123 may include or refer to the S-ribs 123S.

The cross-section of the S-rib 123S may have a shape of a capital letter “S.” For example, the S-rib 123S may extend from the outer layer 121 to the shock-absorbing middle layer 122.

Due to a shape of the S-rib 123S, at least a portion of an impact applied to the S-rib 123S may be absorbed by the S-rib 123S. For example, if an impact is applied to the S-rib 123S, the shape of the S-rib 123S may be deformed, or the S-rib 123S may be fractured.

A plurality of S-ribs 123S may be provided. For example, the shock-absorbing plate 120 may include a plurality of S-ribs 123S. The plurality of S-ribs 123S may be sequentially arranged.

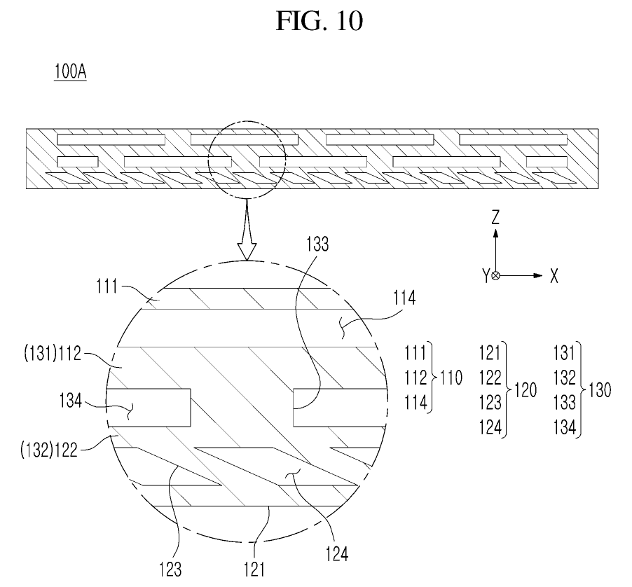

FIG. 10 is a cross-sectional view of an additional plate having an insulation space formed in the insulation plate.

Referring to FIG. 10, an additional plate 100A may include an insulation plate 130.

The insulation plate 130 may be positioned beneath a cooling plate 110. For example, the insulation plate 130 may be coupled or connected to the cooling plate 110. For example, the insulation plate 130 may be integrally formed with the cooling plate 110.

For example, the insulation plate 130 may include an insulating top layer 131 defining an upper surface of the insulation plate 130. The insulating top layer 131 may be coupled to a lower surface of the cooling middle layer 112.

For example, the insulating top layer 131 may be integrally formed with the cooling middle layer 112. In this case, the insulating top layer 131 or the cooling middle layer 112 may be referred to as a “middle top layer.”

The insulation plate 130 may be positioned on the shock-absorbing plate 120. For example, the insulation plate 130 may be coupled or connected to the shock-absorbing plate 120. For example, the insulation plate 130 may be integrally formed with the shock-absorbing plate 120.

For example, the insulation plate 130 may include an insulating bottom layer 132 defining a lower surface of the insulation plate 130. The insulating bottom layer 132 may be coupled to an upper surface of the shock-absorbing middle layer 122.

For example, the insulating bottom layer 132 may be integrally formed with the shock-absorbing middle layer 122. In this case, the insulating bottom layer 132 or the shock-absorbing middle layer 122 may be referred to as a “middle bottom layer.”

The insulation plate 130 may include an insulation space 134. The insulation space 134 may be a hollow portion or space formed in the insulation plate 130. The insulation space 134 may be, for example, a space formed between the insulating top layer 131 and the insulating bottom layer 132. By forming the insulation space 134, heat transfer between the cooling plate 110 and the shock-absorbing plate 120 may be inhibited.

The insulation plate 130 may include an insulating wall 133. The insulating wall 133 may extend downward from the insulating top layer 131 to the insulating bottom layer 132. The insulating wall 133 may define the insulation space 134.

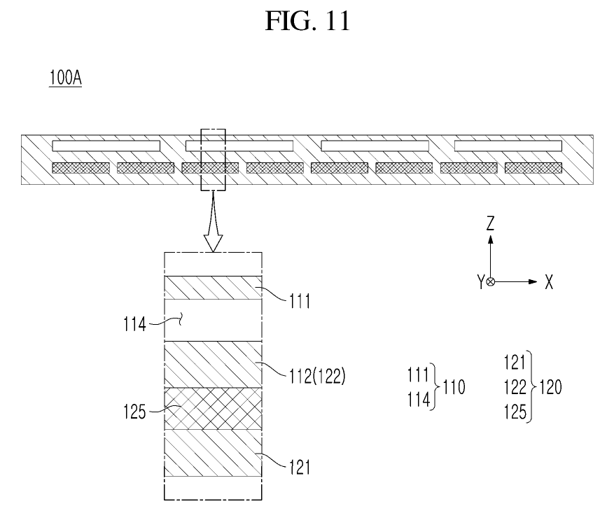

FIG. 11 is a cross-sectional view of an additional plate including a shock-absorbing body.

Referring to FIGS. 7 and 11, a shock-absorbing plate 120 may include a shock-absorbing body 125. The shock-absorbing body 125 may be disposed in or accommodated in a shock-absorbing space 124.

The shock-absorbing body 125 may be formed of a material including an elastic material. For example, the shock-absorbing body 125 may be formed of a material including at least one of polyurethane and silicone.

A battery pack frame 10 according to another embodiment of the present disclosure may include a bottom frame 100, which forms a bottom and includes a loading plate 100L defining an upper surface and an additional plate 100A defining a lower surface.

The battery pack frame 10 may include side frames 200, which extend upward from at least a portion of the perimeter of the loading plate 100L.

The additional plate 100A may include a shock-absorbing plate 120, which includes a cooling plate 110 having a cooling passage 114 formed therein, a shock-absorbing middle layer 122 positioned beneath the cooling plate 110, and an outer layer 121 positioned beneath the shock-absorbing middle layer 122.

The shock-absorbing plate 120 may include a plurality of shock-absorbing ribs 123 that are sequentially arranged and positioned between the shock-absorbing middle layer 122 and the outer layer 121.

Among the plurality of shock-absorbing ribs 123, at least two adjacent shock-absorbing ribs 123 may overlap in the vertical direction.

Each of the plurality of shock-absorbing ribs 123 may be inclined with respect to the outer layer 121 and the shock-absorbing middle layer 122.

The shock-absorbing plate 120 may include a shock-absorbing space 124, which is a space formed between the outer layer 121 and the shock-absorbing middle layer 122.

The shock-absorbing plate 120 may include a shock-absorbing body formed of an elastic material and disposed in the shock-absorbing space 124.

The plurality of shock-absorbing ribs 123 may include a plurality of first arc ribs 123C1 and a plurality of second arc ribs 123C2, which are alternately arranged in one direction. Additionally, a shape of the first arc rib 123C1 may be vertically symmetrical with a shape of the second arc rib 123C2.

Each of the first arc rib 123C1 and the second arc rib 123C2 may include: a main arc 123CM coupled to at least one of the outer layer 121 and the shock-absorbing middle layer 122; and a sub-arc 123CS coupled to the main arc 123CM.

The main arc 123CM of the first arc rib 123C1 may be connected to the outer layer 121 and may be concave toward the outer layer 121, and may be convex toward the shock-absorbing middle layer 122.

The main arc 123CM of the second arc rib 123C2 may be connected to the shock-absorbing middle layer 122 and may be concave toward the shock-absorbing middle layer 122, and may be convex toward the outer layer 121.

The sub-arc 123CS of the first arc rib 123C1 may be convex toward the outer layer 121, and the sub-arc 123CS of the second arc rib 123C2 may be convex toward the shock-absorbing middle layer 122.

The shock-absorbing plate 120 may be detachably coupled to the cooling plate 110 through a coupling part 140.

The additional plate 100A may include an insulation plate 130 formed of an insulating material and disposed between the cooling plate 110 and the shock-absorbing plate 120.

The cooling plate 110 may include: an inner layer 111 defining an upper surface of the cooling plate 110; a cooling middle layer 112 positioned beneath the inner layer 111 and coupled to the shock-absorbing middle layer 122; a cooling passage 114, which is a space formed between the inner layer 111 and the cooling middle layer 112; and a cooling wall 113 positioned between the inner layer 111 and the cooling middle layer 112 and defining the cooling passage 114.

The inner layer 111 may be integrally formed with the loading plate 100L.

The cooling middle layer 112 may be integrally formed with the shock-absorbing middle layer 122.

The additional plate 100A may include the insulation plate 130 disposed between the cooling plate 110 and the shock-absorbing plate 120 and defining an insulation space 134 therein.

The insulation plate 130 may include: an insulating top layer 131 integrally formed with the cooling middle layer 112; an insulating bottom layer 132 integrally formed with the shock-absorbing middle layer 122; and an insulating wall 133 extending downward from the insulating top layer 131 to the insulating bottom layer 132.

The insulation space 134 may be formed between the insulating top layer 131 and the insulating bottom layer 132 and may be defined by the insulating wall 133.

The plurality of shock-absorbing ribs 123 may comprise a plurality of S-ribs 123S, each formed in an “S” shape and having one end coupled to the outer layer 121 and the other end coupled to the shock-absorbing middle layer 122.

The additional plate 100A may include: a plurality of cooling plates 110, each arranged in one direction as the cooling plate 110; and a plurality of shock-absorbing plates, each arranged in the one direction as the shock-absorbing plate 120.

The cooling plate 110 may have a shape extending in the longitudinal direction, and the additional plate 100A may include a plurality of shock-absorbing plates 120, each sequentially arranged in the longitudinal direction as the shock-absorbing plate 120.

The contents described above are merely examples of applying the principles of the present disclosure, and other configurations may be further included without departing from the scope of the present disclosure.

What is claimed is:

1. A battery pack frame comprising:
a bottom frame comprising a loading plate defining an upper surface and an additional plate defining a lower surface; and
side frames having a shape extending upward from at least a portion of a perimeter of the loading plate,
wherein the additional plate comprises:
a cooling plate having a cooling passage formed therein; and
a shock-absorbing plate comprising a shock-absorbing middle layer positioned beneath the cooling plate and an outer layer positioned beneath the shock-absorbing middle layer,
wherein the shock-absorbing plate comprises a plurality of shock-absorbing ribs sequentially arranged between the shock-absorbing middle layer and the outer layer.

2. The battery pack frame according to claim 1, wherein each of the plurality of shock-absorbing ribs is inclined with respect to the outer layer and the shock-absorbing middle layer.

3. The battery pack frame according to claim 1, wherein at least two adjacent shock-absorbing ribs among the plurality of shock-absorbing ribs overlap each other in a vertical direction.

4. The battery pack frame according to claim 1, wherein the shock-absorbing plate comprises a shock-absorbing space formed between the outer layer and the shock-absorbing middle layer.

5. The battery pack frame according to claim 4, wherein the shock-absorbing plate comprises a shock-absorbing body disposed in the shock-absorbing space and formed of an elastic material.

6. The battery pack frame according to claim 1, wherein the plurality of shock-absorbing ribs comprise a plurality of first arc ribs and a plurality of second arc ribs alternately arranged in one direction,
wherein a shape of the first arc rib is vertically symmetrical with a shape of the second arc rib.

7. The battery pack frame according to claim 6, wherein each of the first arc ribs and the second arc ribs comprises:
a main arc coupled to at least one of the outer layer and the shock-absorbing middle layer; and
a sub-arc coupled to the main arc.

8. The battery pack frame according to claim 7, wherein the main arc of the first arc rib is connected to the outer layer and is concave toward the outer layer and convex toward the shock-absorbing middle layer, and
the main arc of the second arc rib is connected to the shock-absorbing middle layer and is concave toward the shock-absorbing middle layer and convex toward the outer layer.

9. The battery pack frame according to claim 8, wherein the sub-arc of the first arc rib is convex toward the outer layer, and
the sub-arc of the second arc rib is convex toward the shock-absorbing middle layer.

10. The battery pack frame according to claim 1, wherein the shock-absorbing plate is detachably coupled to the cooling plate through a coupling part.

11. The battery pack frame according to claim 1, wherein the additional plate is disposed between the cooling plate and the shock-absorbing plate and comprises an insulation plate formed of an insulating material.

12. The battery pack frame according to claim 1, wherein the cooling plate comprises:
an inner layer defining an upper surface of the cooling plate;
a cooling middle layer positioned beneath the inner layer and coupled to the shock-absorbing middle layer;
the cooling passage, which is a space formed between the inner layer and the cooling middle layer; and
a cooling wall positioned between the inner layer and the cooling middle layer and defining the cooling passage.

13. The battery pack frame according to claim 12, wherein the inner layer is integrally formed with the loading plate.

14. The battery pack frame according to claim 12, wherein the cooling middle layer is integrally formed with the shock-absorbing middle layer.

15. The battery pack frame according to claim 12, wherein the additional plate further comprises an insulation plate disposed between the cooling plate and the shock-absorbing plate and having an insulation space formed therein.

16. The battery pack frame according to claim 15, wherein the insulation plate comprises:
an insulating top layer integrally formed with the cooling middle layer;
an insulating bottom layer integrally formed with the shock-absorbing middle layer; and
an insulating wall extending downward from the insulating top layer to the insulating bottom layer.

17. The battery pack frame according to claim 16, wherein the insulation space is formed between the insulating top layer and the insulating bottom layer and is defined by the insulating wall.

18. The battery pack frame according to claim 1, wherein the plurality of shock-absorbing ribs comprises a plurality of S-ribs, each formed in an “S” shape and having one end coupled to the outer layer and the other end coupled to the shock-absorbing middle layer.

19. The battery pack frame according to claim 1, wherein the additional plate comprises:
a plurality of cooling plates, each arranged in one direction as the cooling plate; and
a plurality of shock-absorbing plates, each arranged in the one direction as the shock-absorbing plate.

20. The battery pack frame according to claim 1, wherein the cooling plate has a shape extending in a longitudinal direction, and
the additional plate comprises a plurality of shock-absorbing plates, each arranged sequentially in the longitudinal direction as the shock-absorbing plate.
